(19) United States
(12) Patent Application Publication
(10) Pub. No.: US 2015/0104674 A1
(43) Pub. Date: Apr. 16, 2015

(54) RECHARGEABLE BATTERY

(71) Applicant: SAMSUNG SDI CO., LTD., Yongin-si (KR)

(72) Inventors: Minyeol HAN, Yongin-si (KR); Haekwon YOON, Yongin-si (KR); Chiyoung LEE, Yongin-si (KR); Hyungyu PARK, Yongin-si (KR); Yonghee YUN, Yongin-si (KR)

(73) Assignee: SAMSUNG SDI CO., LTD., Yongin-si (KR)

(21) Appl. No.: 14/227,135

(22) Filed: Mar. 27, 2014

(30) Foreign Application Priority Data
Oct. 11, 2013 (KR) 10-2013-0121492

(51) Int. Cl. H01M 2/34; H01M 2/12

(52) U.S. Cl. CPC H01M 2/345; H01M 2/1223; H01M 2200/20
USPC 429/7

(57) ABSTRACT

A rechargeable battery includes a short-circuit path connected to a first terminal and spaced from a second terminal. The short-circuit path changes direction at least once, and may be formed from one or more conductive surfaces. The short-circuit path establishes a first short circuit when the battery receives a force in a first direction, and a second short circuit when the battery receives a force in a second direction. Each short-circuit path delivers a current to a fuse coupled to the second terminal. The first and second short circuits are established independently from one another based on different forces applied to the battery.

### CROSS-REFERENCE TO RELATED APPLICATION

Korean Patent Application No. 10-2013-0121492, filed on Oct. 11, 2013, and entitled, “Rechargeable Battery,” is incorporated by reference herein in its entirety.

### BACKGROUND

1. Field

One or more embodiments described herein relate to a battery.

2. Description of the Related Art

Unlike a primary battery, a secondary battery is chargeable and dischargeable. A low-capacity rechargeable battery includes a battery cell in a pack. This type of battery has been used in portable electronic devices such as cellular phones and camcorders. A high-capacity battery may include dozens of connected battery cells, and has been used in hybrid vehicles.

A rechargeable battery may include an electrode assembly having positive and negative plates. An insulating separator is interposed between the plates, and the assembly is placed in a case containing an electrolyte. A cap plate is installed on the case, and electrodes connected to the positive and negative plates are exposed or protrude through the cap plate.

During operation, a rechargeable battery may ignite or explode as a result of various error conditions. These conditions include a short circuit, and over-charge condition, or damage caused by a penetration test of the battery.

### SUMMARY

In accordance with one or more embodiments, a rechargeable battery includes an electrode assembly including a separator between a first electrode layer and a second electrode layer; a case including the electrode assembly and having an opening; a cap assembly over the opening of the case; a first terminal connected to the first electrode layer; and a short-circuit structure spaced from the cap assembly, wherein the short-circuit structure includes a first plate having a first side connected to the first terminal and a second plate connected to a second side of the first plate, and wherein the second plate is between the first plate and the cap assembly.

The short-circuit structure may include an insulation plate between the first and second plates. The first and second plates may be substantially parallel to the cap assembly. The second plate may have a first surface facing and spaced from the first electrode plate, and a second surface facing and connected to the second side of the first plate.

The short-circuit structure may include a protrusion plate connected to the second surface of the second plate and protruding toward the first electrode plate. The cap assembly may have a short-circuit hole under the protrusion plate, the short-circuit hole passing through top and bottom surfaces of the cap assembly.

The cap assembly may include a cap plate to seal the case, a short-circuit hole formed in the cap plate, and the cap plate includes a vent plate configured to be open when an internal pressure of the case is greater than or equal to a preset pressure. The cap assembly may include an inversion plate in the short-circuit hole of the cap plate, the inversion plate to move to be electrically connected to the cap when the internal pressure of the case increases.

The cap may include an insulation support on the second plate, the insulation support electrically disconnected from the second plate. The cap may include a first insulation support on the cap assembly to support a first side of the second plate, and a second insulation support on the cap assembly to support a second side of the second plate adjacent to the short-circuit hole of the cap assembly.

The battery may include a first collector plate connecting the first electrode layer to the first terminal, a second collector plate connected to the second electrode layer, and a second terminal connected to the second collector plate and upwardly protruding from the cap assembly. The second collector plate includes a second electrode connector connected to the second electrode layer, a second terminal connector connected to the second terminal, and a coupler connecting the second electrode connector and the second terminal connector, and having a fuse hole formed therein.

The short-circuit structure nay be formed as a single body, and the first and second ends of the first plate may overlap. A length of the first plate may be greater than a length of the second plate.

In accordance with another embodiment, a rechargeable battery includes an electrode assembly including a separator between a first electrode layer and a second electrode layer; a case including the electrode assembly and an opening; a cap assembly over the opening; a first terminal connected to the first electrode layer; and a short-circuit structure spaced from the cap assembly and connected to the first terminal, wherein the short-circuit structure has at least two overlapping layers.

In accordance with another embodiment, a rechargeable battery includes a case; a first terminal; a second terminal; and a short-circuit path connected to the first terminal, wherein the short-circuit path is spaced from the second terminal and changes direction at least once, and wherein the short-circuit path establishes a first short circuit when the battery receives a force in a first direction and a second short circuit when the battery receives a force in a second direction, each of the first and second short-circuit paths delivering a current to a fuse coupled to the second terminal.

The short-circuit path may pass through a first conductive surface overlapping a second conductive surface. The short-circuit path may pass through a folded plate. The short-circuit structure may contact a cap on the case connected to the second terminal to establish the first short circuit, and may contact the second terminal to establish the second short circuit, the first and second short circuits established independently from one another based on different forces applied to the battery.

### BRIEF DESCRIPTION OF THE DRAWINGS

Features will become apparent to those of skill in the art by describing in detail exemplary embodiments with reference to the attached drawings in which:

FIG. 1 illustrates an embodiment of a rechargeable battery;

FIG. 2 illustrates a view of the battery along section line 2-2 in FIG. 1;

FIG. 3 illustrates an exploded view of a short-circuit plate in FIG. 1; and

FIG. 4 illustrates an enlarged view of the short-circuit plate.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

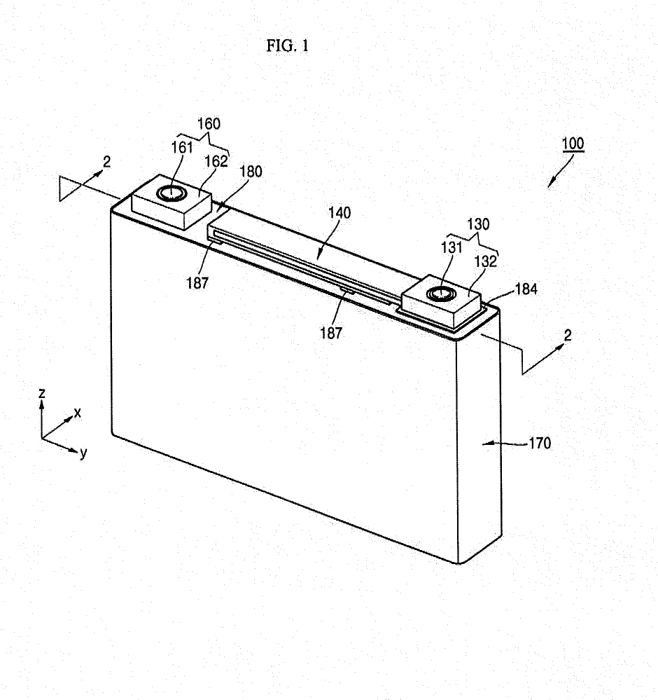

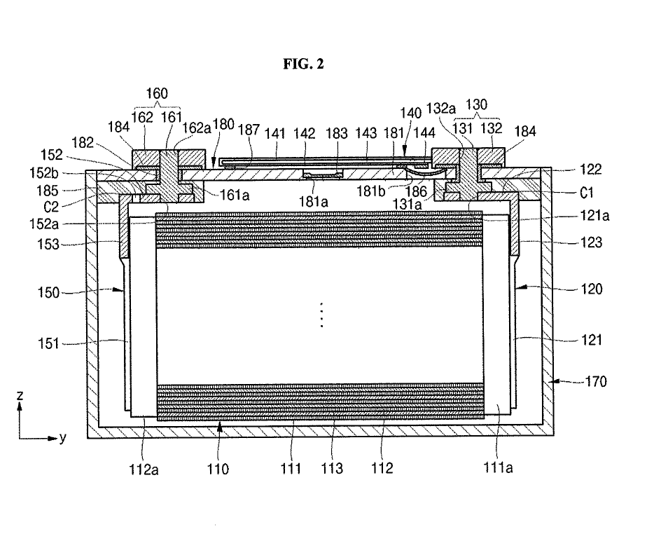

FIG. 1 illustrates an embodiment of a rechargeable battery 100, and FIG. 2 illustrates a cross-sectional view of the rechargeable battery taken along line 2-2 in FIG. 1. As illustrated in FIGS. 1 and 2, rechargeable battery 100 includes an electrode assembly 110, a first collector plate 120, a first terminal part 130, a short-circuit structure 140, a second collector plate 150, a second terminal part 160, a case 170, and a cap assembly 180. The rechargeable battery 100 may include a plurality of battery cells connected in series or parallel to each other to output a high voltage, thereby forming a large-capacity battery pack. In other embodiments, the rechargeable battery have fewer battery cells (connected in series or parallel), or even one battery cell, to output a predetermined voltage.

The electrode assembly 110 may be formed by winding or laminating a stacked structure including a first electrode plate 111, a separator 113, and a second electrode plate 112 Each of the plates 111 and 112 may have a thin plate shape or may be a thin foil, or may correspond to another type of conductive surface. The first electrode plate 111 may function as a positive electrode and the second electrode plate 112 may function as a negative electrode.

The first electrode plate 111 may be formed by applying a first electrode active material (e.g., a transition metal oxide) on a first electrode collector, formed of a metal foil made of copper or nickel. The first electrode plate 111 may also include a first electrode uncoated portion 111a, on which the first electrode active material is not applied. The first electrode uncoated portion 111a may function as a passage for current flowing between the first electrode plate 111 and an element outside of the first electrode plate 111.

The second electrode plate 112 may be formed by applying a second electrode active material (e.g., graphite or carbon) on a second electrode collector, formed of a metal foil such as aluminum. The second electrode plate 112 may include a second electrode uncoated portion 112a, on which the second electrode active material is not applied. The second electrode uncoated portion 112a may function as a passage for current flowing between the second electrode plate 112 and an element outside of the second electrode plate 112.

A separator 113 may be disposed between adjacent ones of the first electrode plate 111 and the second electrode plate 112, to prevent electrical short circuits and to allow movement of, for example, lithium ions. The separator 113 may be formed, for example, of polyethylene, polypropylene, or a composite film made of polypropylene and polyethylene.

The first collector plate 120 and second collector plate 150 are electrically connected to the first electrode plate 111 and second electrode plate 112, respectively, at corresponding ends of the electrode assembly 110. More specifically, the first collector plate 120 and second collector plate 150 are respectively coupled to the first electrode uncoated portion 111a and the second electrode uncoated portion 112a at corresponding ends of the electrode assembly 110.

The electrode assembly 110 is accommodated in the case 160 with an electrolytic solution. The electrolytic solution may include, for example, an organic solvent such as ethylene carbonate (EC), propylene carbonate (PC), diethyl carbonate (DEC), ethyl methyl carbonate (EMC), or dimethyl carbonate (DMC), and a lithium salt such as LiPF6 or LiBF4. The electrolytic solution may be a liquid, a solid, or a gel.

The first collector plate 120 includes a first electrode connecting part 121 connected to the first electrode plate 111, a first terminal connecting part 122 connected to the first terminal part 130, and a first coupling part 123 connecting the first electrode connecting part 121 to the first terminal connecting part 122. In one embodiment, the first collector plate 120 is formed as a single body. The first collector plate 120 includes a corner portion formed by bending the first coupling part 123 into, for example, a substantially ‘L’ shape. The first collector plate 120 may be formed of a conductive material such as, for example, copper, a copper alloy, or equivalents thereof.

The first electrode connecting part 121 makes contact with the first electrode uncoated portion 111a, which protrudes to one end of the electrode assembly 110. This arrangement allows the first electrode connecting part 121 to be electrically connected to the first electrode plate 111. The first electrode connecting part 121 may be welded (or otherwise connected) to the first electrode uncoated portion 111a, and may be configured, for example, to stand in a vertical direction.

The first terminal connecting part 122 may be welded (or otherwise connected) to the first terminal part 130. The first terminal connecting part 122 may be in the shape of a plate lying in a substantially horizontal direction. The first terminal connecting part 122 is installed between a cap plate 181 of the cap assembly 180 and the electrode assembly 110. A first fastening hole 122a is formed in the first terminal connecting part 122 to pass through top and bottom surfaces of the first terminal connecting part 122. A first fastening terminal 131 of the first terminal part 130 is fitted into and coupled to the first fastening hole 122a. That is, the first fastening hole 122a may be sized to fit the first fastening terminal 131, in order to receive the first fastening terminal 131.

One side of the first coupling part 123 is connected to the first electrode plate connecting part 121, and the other side of the first coupling part 123 is connected to the first terminal connecting part 122. The first coupling part 123 has a corner portion bent between the sides and may have a substantially ‘L’ shape.

The first terminal part 130 may be formed of a metal and/or another material, and is electrically connected to the first collector plate 120. The first terminal part 130 includes a first fastening terminal 131 received in the first fastening hole 122a of the first collector plate 120, and a first electrode terminal 132 coupled to the first fastening terminal 131.

The first fastening terminal 131 passes through the cap plate 181, upwardly extends and protrudes a predetermined length, and then is electrically connected to the first collector plate 120 under the cap plate 181. The first fastening terminal 131 extends and protrudes a predetermined length upwardly from the cap plate 181. The first fastening terminal 131 may have a flange 131a formed under the cap plate 181, to laterally extend so as to prevent the first fastening terminal 131 from being dislodged from the cap plate 181. A region of the first fastening terminal 131, formed under the flange 131a, may be inserted into the first fastening hole 122a of the first collector plate 120. This region of the first fastening terminal 131 may then be riveted, welded, or otherwise secured. In addition, a region of the first fastening terminal 131, formed on the flange 131a, passes through the cap plate 181. The first electrode terminal 132 may be fixed to the extending and protruding region.

The first electrode terminal 132 may have a plate shape having a first terminal hole 132a passing through top and bottom surfaces of the first electrode terminal 132. The first terminal hole 132a of the first electrode terminal 132 may be sized and shaped to fit the first fastening terminal 131, in order to receive the first fastening terminal 131 in a horizontal direction of the first electrode terminal 132. The first fastening terminal 131 upwardly protrudes from the cap plate 181 and is fitted into the first terminal hole 132a of the first electrode terminal 132, to then be riveted or welded.

The short-circuit structure 140 has one side welded (or otherwise attached) to the first terminal part 130 and has a plate shape lying in a substantially horizontal direction. The short-circuit structure 140 is installed on and spaced from the cap plate 181 of the cap assembly 180. The short-circuit structure 140 may be disposed to be parallel to the cap plate 181, but this is not necessary. In addition, the short-circuit structure 140 has another side adjacent to and spaced from the second terminal part 160.

In one embodiment, the short-circuit structure 140 may have at least a double layered structure including a first short-circuit plate 141 and a second short-circuit plate 142 overlapping each other. The first short-circuit plate 141 and the second short-circuit plate 142 may be made of a metal or another material and are electrically connected to the first terminal part 130. In other embodiments, one or more additional plates (e.g., a multi-layered structure having three or more plates) may be included in the short-circuit structure, which may or may not overlap short-circuit plates 141 and 142. In other embodiments, the short circuit structure may change direction at least once in a same plane. Such an embodiment may have a single or multiple plates, at least one of which that change direction at least once.

In addition, the short-circuit structure 140 may include an insulation plate 143 between the first and second short-circuit plates 141 and 142. In addition, the short-circuit structure 140 may include a protrusion plate 144 welded (or otherwise attached) to a bottom surface of the other side of second short-circuit plate 142.

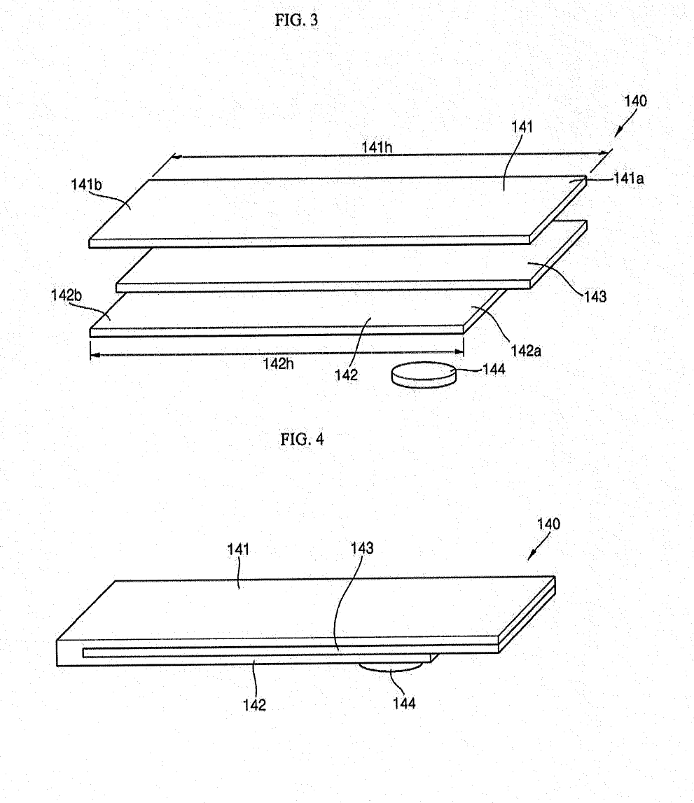

FIGS. 3 and 4 illustrate exploded and enlarged views of the short-circuit structure 140. As illustrated in FIGS. 3 and 4, the first short-circuit plate 141 has a plate shape having two sides. One side 141a in the lengthwise direction (Y) is attached (e.g., welded) to the first terminal part 130. The other side 141b is attached (e.g., welded) to the other side 142b of the second short-circuit plate 142. The first short-circuit plate 141 electrically connects the first terminal part 130 and the other side 142b of the second short-circuit plate 142. The bottom surface of the first short-circuit plate 141 overlaps, and in some embodiments is brought into contact with, the top surface of the insulation plate 143.

The second short-circuit plate 142 is positioned on and spaced from a top surface of the cap plate 181. The second short-circuit plate 142 has one side 142a in the lengthwise direction (Y) spaced apart from the first terminal part 130 and the other side 142b welded and connected to the bottom surface of the other side 141b of the first short-circuit plate 141. That is, sides 141b and 142b of the first and second short-circuit plates 141 and 142, which overlap each other, may be attached (e.g., welded) to each other.

In an alternative embodiment, the first and second short-circuit plates 141 and 142 may be formed of a single plate without a separate welding process. For example, side 141b of the first short-circuit plate 141 and side 142b of the second short-circuit plate 142 may be bent at 180 degrees, so that the bottom surface of the first short-circuit plate 241 and the top surface of the second short-circuit plate 242 face top and bottom surfaces of the insulation plate 143, respectively.

The insulation plate 143 is located between the bottom surface of the first short-circuit plate 141 and the top surface of the second short-circuit plate 142. In addition, attached sides 141b and 142b are adjacent an edge of the insulation plate 143. The insulation plate 143 prevents the first short-circuit plate 141 and the second short-circuit plate 142 from electrically contacting each other. That is, side 141b of the first short-circuit plate 141 and side 142b of the second short-circuit plate 142 are connected to each other, and parts of the first and second short-circuit plates 141 and 142 and sides 141b 142b are prevented from contacting each other by the insulation plate 143.

A length 141h of the first short-circuit plate 141 corresponds to a distance between ends of the first short-circuit plate 141 in the lengthwise direction. In one embodiment, this distance is greater than a length 142h between ends of the second short-circuit plate 142 in the lengthwise direction. Therefore, end 142a of the second short-circuit plate 142 is spaced apart the first terminal part 130 by a difference between the length 142h of the first short-circuit plate 141 and the length 142h of the second short-circuit plate 142.

The protrusion plate 144 is attached (e.g., welded) to the bottom surface of one side of the second short-circuit plate 142, and downwardly protrudes from the second short-circuit plate 142. The protrusion plate 144 may be made of a metal or another material, and is electrically connected to the second short-circuit plate 142. In one embodiment, the short-circuit structure 140 has a double layered structure to increase the internal resistance of the short-circuit structure 140. As previously indicated, the double layered structure may include end 141b of the first short-circuit plate 141 connected to an end 142b of the second short-circuit plate 142.

The second collector plate 150 includes a second electrode connecting part 151 connected to the second electrode plate 112, a second terminal connecting part 152 connected to the second terminal part 160, and a second coupling part 153 connecting the second electrode connecting part 151 to the second terminal connecting part 152. The second collector plate 150 may be formed as a single body. Also, the second collector plate 150 may include a corner portion formed by bending the second coupling part 153 into, for example, a substantially ‘L’ shape. The second collector plate 150 may be formed of a conductive material including, for example, aluminum or an aluminum alloy.

The second electrode connecting part 151 contacts the second electrode uncoated portion 112a (protruding toward one end of the electrode assembly 110), to establish electrical connection with second electrode plate 111. The second electrode connecting part 151 is attached (e.g., welded) to the second electrode uncoated portion 112a to stand, for example, in a vertical direction.

The second terminal connecting part 152 is attached (e.g., welded) to the second terminal part 160, and may have a plate shape lying in a substantially horizontal direction. The second terminal connecting part 152 is installed between the cap plate 181 of the cap assembly 180 and the electrode assembly 110.

A second fastening hole 152a and a fuse hole 152b are formed in the second terminal connecting part 152, and pass through top and bottom surfaces of the second terminal connecting part 152. A second fastening terminal 161 of the second terminal part 160 is fitted for connection to the second fastening hole 152a. That is, the second fastening hole 152a may be sized to fit and receive the second fastening terminal 161.

The fuse hole 152b is positioned at a region adjacent to a corner C2 of the second terminal connecting part 152. In this position, fuse hole 152b does not overlap the second fastening hole 152a coupled to the second fastening terminal 161. The fuse hole 152b makes a cross-sectional area of the region where the fuse hole 152b is formed smaller than that of the other region of the second terminal connecting part 152.

The region where the fuse hole 152b is formed may be melted by high heat generated when a predetermined current (e.g., 3000 A or higher) instantaneously flows due to a high-current short circuit occurring in the rechargeable battery 100. As a result, the fuse hole may function as a fuse that cuts off the flow of current.

When the internal pressure of the rechargeable battery 100 exceeds a preset pressure (due to heat generated, for example, by an over-charge condition of the rechargeable battery 100 and an attendant decomposition of an electrolytic solution), a high-current short circuit may be caused by contact between an inversion plate 186 of the cap assembly 180 and the short-circuit structure 140. A high-current short circuit may also be caused by contact between the second terminal part 160 and the adjacent end of the short-circuit structure 140, when the rechargeable battery 100 is compressed in the Y-axis direction. A high-current short circuit may also be caused by contact between cap plate 181 and the bottom surface of the second short-circuit plate 142, when the rechargeable battery 100 is compressed in the Z-axis direction rechargeable battery 100.

When a high-current short circuit occurs in the region where fuse hole 152b is formed, the region where the fuse hole 152b is formed is melted to cut off the flow of current. As a result, charging or discharging of the rechargeable battery 100 may be stopped before the rechargeable battery 100 causes a dangerous situation, such as ignition or explosion.

Referring again to FIG. 2, as previously indicated, one side of the second coupling part 153 is connected to the second electrode connecting part 151. The other side of the second coupling part 153 is connected to the second terminal connecting part 152. The second coupling part 153 includes a corner portion C2 bent between sides of the second coupling part to have a substantially ‘L’ shape.

The second terminal part 160 may be formed of a metal or other material, and is electrically connected to the second collector plate 150. In addition, the second terminal part 160 is electrically connected to the cap plate 181. The second terminal part 160 includes a second fastening terminal 161 and a second electrode terminal. The second fastening terminal 161 is received in a second fastening hole 152a of the second collector plate 150. The second electrode terminal 162 is coupled to the second fastening terminal 161.

The second fastening terminal 161 passes through the cap plate 181, upwardly extends and protrudes a predetermined length, and is electrically connected to the second collector plate 150 under the cap plate 181. The second fastening terminal 161 extends and protrudes a predetermined length upwardly from the cap plate 181, and may have a flange 161a formed under the cap plate 181 that laterally extends to prevent the second fastening terminal 161 from being dislodged from the cap plate 181.

A region of the second fastening terminal 161, formed under the flange 161a, may be inserted into the second fastening hole 152a of the second collector plate 150. This region may then be riveted or welded for attachment to the hole. In addition, a region of the second fastening terminal 161, formed on the flange 161a, passes through the cap plate 181. The second electrode terminal 162 may be fixed to the extending and protruding region.

The second electrode terminal 162 may have a plate shape having a second terminal hole 162a passing through top and bottom surfaces of the second electrode terminal 162. The terminal hole 132a of the first electrode terminal 132 may be sized and shaped to fit and receive the first fastening terminal 131. The first fastening terminal 131 upwardly protrudes from the cap plate 181 and is fitted into the second terminal hole 132a of the first electrode terminal 132, where it is then riveted or welded.

The second terminal part 160 may be made of, for example, aluminum or an aluminum alloy or another material.

The case 170 may be formed of a conductive metal, such as aluminum, an aluminum alloy or a nickel-plated steel, and may have an approximately hexahedron shape provided with an opening through which the electrode assembly 110, the first collector plate 120, and the second collector plate 150 are inserted. (Because the case 170 and the cap assembly 180 are illustrated in an assembled state in FIGS. 1 and 2, the opening of the case is not shown. However, it is to be understood that the opening may correspond to a substantially opened portion of the edge of the cap assembly 180.) Also, the inner surface of case 170 may be treated to be insulated from the electrode assembly 110, the first collector plate 120, the second collector plate 150, and the cap assembly 180.

The cap assembly 180 may be coupled to the case 170. For example, the cap assembly 180 may include a cap plate 181, a seal gasket 182, a safety vent 183, an upper insulation member 184, a lower insulation member 185, an inversion plate 186, and an insulation support unit 187.

The cap plate 181 closes the opening of the case 170. The cap plate 181 may be formed of the same or a different material as that of the case 170. For example, the cap plate 181 may be coupled to the case 170 by laser welding. The cap plate 181 is electrically connected to the first terminal part 130, so that the cap plate 181 and the first terminal part 130 may have the same polarity. Accordingly, the cap plate 181 may have the same polarity as that of the case 170.

The cap plate 181 includes a vent hole 181a and a short-circuit hole 181b passing through top and bottom surfaces of the cap plate 181. The short-circuit hole 181b is positioned adjacent a bottom portion of a protrusion plate 144, connected to the bottom surface of the second short-circuit plate 142.

A seal gasket 182 may be formed of an insulating material disposed between each of the first fastening terminal 131 and the second fastening terminal 161 and the cap plate 181, to seal spaces between cap plate 181 and corresponding ones of the first and second fastening terminals 131 and 161. The seal gasket 182 may prevent the introduction of external moisture into the rechargeable battery 100, and/or leakage of the electrolytic solution from the rechargeable battery 100.

The safety vent 183 is installed in the vent hole 181a of the cap plate 181 and may have a notch configured to be opened at a preset pressure.

The upper insulation member 184 is formed between the first electrode terminal 132 and cap plate 181, to thereby electrically insulate the first electrode terminal 132 from the cap plate 181. In addition, the upper insulation member 184 may contact cap plate 181. Further, the upper insulation member 184 may contact seal gasket 182. The upper insulation member 184 insulates first terminal part 130 from the cap plate 181.

In addition, the upper insulation member 184 may be formed between the second electrode terminal 162 and cap plate 181. In this case, a portion of the second electrode terminal 162 may contact and thus be electrically connected to cap plate 181.

A lower insulation member 185 is formed between each of the first collector plate 120 and the second collector plate 150 and the cap plate 181, to thereby prevent unnecessary short circuits from occurring between them. That is, the lower insulation member 185 may prevent short circuits between the first collector plate 120 and the cap plate 181 and between the second collector plate 150 and the cap plate 181. A lower insulation member 185 may also be formed between each of the first and second electrode terminals 132 and 162 and cap plate 181, to thereby prevent unnecessary short circuits from occurring between each of the first and second electrode terminals 132 and 162 and cap plate 181.

The inversion plate 186 is disposed between the upper insulation member 184 and the cap plate 181, in a short-circuit hole 181b of the cap plate 181. In one embodiment, the inversion plate 186 includes a downwardly convex round part and a flange part fixed to the cap plate 181.

The inversion plate 186 may be inverted to protrude upwardly in a convex shape when the internal pressure of the rechargeable battery 100 exceeds a preset pressure, due to an over-charge condition in the rechargeable battery 100. When the short-circuit plate 186 protrudes in this manner because of the excessive internal pressure, the short-circuit plate 186 may contact the protrusion plate 144 to thereby cause a short circuit. That is, the inversion plate 186 may be positioned under the protrusion plate 144 of the short-circuit structure 140. If the inversion plate 186 is inverted to contact with the short-circuit structure 140, a large amount of current flows and heat is generated. A region of the second collector plate 150 where fuse hole 151a is formed melts to function as a fuse.

The insulation support unit 187 is formed on the top surface of cap plate 181, to support the bottom surface of the short-circuit structure 140. The insulation support unit 187 may prevent the cap plate 181 and short-circuit structure 140 from contacting each other. That is, the insulation support unit 187 is interposed between the bottom surface of the second short-circuit plate 142 and the top surface of the cap plate 181.

In one embodiment, two or more insulation support units 187 may be formed to support the second short-circuit plate 142 at opposite sides and/or intervening positions. For example, one insulation support unit 187 may be formed adjacent to short-circuit hole 181b of cap plate 181 at one side of the second short-circuit plate 142. Another insulation support unit 187 may be formed on the bottom surface at the opposing side of the second short-circuit plate 142. In this configuration, the insulation support units 187 support and fix opposing ends of the second short-circuit plate 142, thereby preventing the cap plate 181 from contacting the second short-circuit plate 142.

In rechargeable battery 100, the resistance of short-circuit structure 140 is increased by double (or multi) layered structure. The increased resistance may reduce a current value generated when a high-current short circuit occurs, and thus may prevent the inversion plate 186 from being damaged due to high current. Therefore, the inversion plate 186 may melt before the fuse due to instantaneously high heat generated based on the high current when a short circuit is caused. As a result, the fuse may not operate, thereby preventing safety of the rechargeable battery 100 from being lowered.

In addition, as previously indicated, the short-circuit structure 140 is electrically connected to the first terminal part 130 and is adjacent (e.g., parallel) to a top portion of the cap plate 181. As a result, the short-circuit structure 140 may contact cap plate 181 when the rechargeable battery 100 is compressed in the Y-axis direction, thereby causing a short circuit between the short-circuit structure 140 and cap plate 181 which have different polarities.

In addition, in the rechargeable battery 100, the short-circuit structure 140 is adjacent to and spaced from the second terminal part 160. A short circuit may be caused between the short-circuit structure 140 and second terminal part 160 (which have different polarities) when the rechargeable battery 100 is compressed in the Z-axis direction. If such a short circuit occurs, the region of second collector plate 150 where the fuse hole 152a is formed may melt to cut off the flow of current, thereby improving the safety of the rechargeable battery 100.

In the aforementioned embodiments, the short-circuit structure 140 is described as including two or more overlapping plates. The plates may be any one of a variety of conductive surfaces, for example, which change direction at least once and which may flex when force is applied. Moreover, the short-circuit structure 140 may carry current along different paths to the fuse for independently establishing a short circuit when forces are applied, for example, in different directions.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
an electrode assembly including a separator between a first electrode and a second electrode;
a case including the electrode assembly and having an opening;
a cap assembly over the opening of the case;
a first terminal connected to the first electrode; and
a short-circuit structure spaced from the cap assembly, wherein the short-circuit structure includes a first plate having a first side connected to the first terminal and a second plate connected to a second side of the first plate, and wherein the second plate is between the first plate and the cap assembly.

2. The battery as claimed in claim 1, wherein the short-circuit structure includes an insulation plate between the first and second plates.

3. The battery as claimed in claim 1, wherein the first and second plates are substantially parallel to the cap assembly.

4. The battery as claimed in claim 1, wherein the second plate has:
a first surface facing and spaced from the first electrode, and
a second surface facing and connected to the second side of the first plate.

5. The battery as claimed in claim 4, wherein the short-circuit structure includes a protrusion plate connected to the second surface of the second plate and protruding toward the first electrode.

6. The battery as claimed in claim 5, wherein the cap assembly has a short-circuit hole under the protrusion plate, the short-circuit hole passing through top and bottom surfaces of the cap assembly.

7. The battery as claimed in claim 6, wherein the cap assembly includes:
a cap plate to seal the case,
a short-circuit hole formed in the cap plate, and
the cap plate includes a vent plate configured to be open when an internal pressure of the case is greater than or equal to a preset pressure.

8. The battery as claimed in claim 7, wherein the cap assembly includes an inversion plate in the short-circuit hole of the cap plate, the inversion plate to move to be electrically connected to the cap when the internal pressure of the case increases.

9. The battery as claimed in claim 7, wherein the cap includes an insulation support on the second plate, the insulation support electrically disconnected from the second plate.

10. The battery as claimed in claim 7, wherein the cap includes:
a first insulation support on the cap assembly to support a first side of the second plate, and
a second insulation support on the cap assembly to support a second side of the second plate adjacent to the short-circuit hole of the cap assembly.

11. The battery as claimed in claim 1, further comprising:
a first collector plate connecting the first electrode to the first terminal.

12. The battery as claimed in claim 11, further comprising:
a second collector plate connected to the second electrode; and
a second terminal connected to the second collector plate and upwardly protruding from the cap assembly.

13. The battery as claimed in claim 12, wherein the second collector plate includes:
a second electrode connector connected to the second electrode;
a second terminal connector connected to the second terminal; and
a coupler connecting the second electrode connector and the second terminal connector, and having a fuse hole formed therein.

14. The battery as claimed in claim 1, wherein:
the short-circuit structure is formed as a single body, and
first and second ends of the first plate overlap.

15. The battery as claimed in claim 1, wherein a length of the first plate is greater than a length of the second plate.

16. A rechargeable battery, comprising:
an electrode assembly including a separator between a first electrode and a second electrode;
a case including the electrode assembly and an opening;
a cap assembly over the opening;
a first terminal connected to the first electrode; and
a short-circuit structure spaced from the cap assembly and connected to the first terminal, wherein the short-circuit structure has at least two overlapping layers.

17. A rechargeable battery, comprising:
a case;
a first terminal;
a second terminal; and
a short-circuit path connected to the first terminal,
wherein the short-circuit path is spaced from the second terminal and changes direction at least once, and wherein the short-circuit path establishes a first short circuit when the battery receives a force in a first direction and a second short circuit when the battery receives a force in a second direction, each of the first and second short-circuit paths delivering a current to a fuse coupled to the second terminal.

18. The battery as claimed in claim 17, wherein the short-circuit path passes through a first conductive surface overlapping a second conductive surface.

19. The battery as claimed in claim 17, wherein the short-circuit path passes through a folded plate.

20. The battery as claimed in claim 17, wherein:
the short-circuit structure contacts a cap on the case connected to the second terminal to establish the first short circuit, and
the short-circuit structure contacts the second terminal to establish the second short circuit, the first and second short circuits established independently from one another based on different forces applied to the battery.
